(19) United States
(12) Patent Application Publication
(10) Pub. No.: US 2005/0092354 A1
(43) Pub. Date: May 5, 2005

(54) Automated lance system for lancing along the annuals of a steam generator

(76) Inventors: Woo Tae Jeong, Taejon (KR); Sung Yull Hong, Taejon (KR)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/700,480

(22) Filed: Nov. 5, 2003

(51) Int. Cl. B08B 3/02

(52) U.S. Cl. 134/180; 134/181; 134/198; 134/174

(57) ABSTRACT

An automated lance system 1 is installed along the annulus of a nuclear power plant steam generator with a tube array of triangular pattern by means of a slidable guide support rail. The guide support rail 2, which is composed of two parallel circular rods 4 separated vertically with a distance, is tightly fixed inside the hand holes. The guide support rail extends from a hand hole at 0 degree to the other hand hole at 90 or 180 degree. The lance body 3 is slideably held on the guide rail by means of supporting circular holders 26 which are attached both on the bottom and on the upper plates of the lance body. The lance body is comprised of a nozzle block 6 with a nozzle cylinder 7 and a first drive means 9 which makes sweeping motion of the nozzle cylinder, a second drive means 12 which aligns the direction of nozzle jets from the nozzle cylinder by rotating the nozzle block in the horizontal plane, and two side support wheels 23 attached to the outer side plate of the lance body, rolling along the inner wall of the steam generator during lancing. For the transportation of the lance, two control cables 27 which extend outward through the hand holes are attached to both ends of the lance body and are driven by a drive means with a drum 28.

### BACKGROUND OF THE INVENTION

1. Field of the Invention

The present invention relates generally to an automated lance system for lancing along the annuals of a system generator.

2. Description of the Related Art

A steam generator in a nuclear power plant of pressurized water reactor type is composed of a bundle of reverse U-shaped thin wall tubes. The tubes function as a heat exchanger and are tightly packed over a tubesheet in a matrix-like pattern. The cross sectional plane view of the steam generator over the tubesheet shows four distinctive regions: The hot leg region where one leg of the U-shaped tube passes and through which hot reactor collant is pumped in, the cold leg region where the other leg of the U-shaped tube ends and through which hot reactor coolant is pumped out after heat exchange with the feed water around the tubes, the blowdown lane with no tubes and the annulus region which occupies the space between the outermost tubes and the inner wall of the steam generator. Feed water encompassing the heat transfer tubes under high pressure is heated above the boiling point to several hundred degrees, thus evaporating into steam which rotates turbines to generate electricity.

In this heat transfer process, some impurities contained in the feed water deposit around the tubes over the tubesheet. Under high operating temperature, the impurities experience chemical reactions and gradually become solid deposits, resulting in lower hear transfer rate of the tubes. Thus, in order to remove these sludge deposits, the steam generator needs to be cleansed periodically. The prior arts have focused on developing lance systems which employed high pressure water jets by means of mechanical methods, to remove effectively and efficiently sludge deposits, which are mainly accessible to the blowdown lane through hand holes with a diameter of 6 to 7 inches which are positioned above the tubesheet. In some rare situations, where the blowdown lance is occupied by other functional part and has less accessible space, lance systems accessible to the annulus have been attempted.

From the literature survey, it has been found that the lance system along the annulus of a steam generator has been rarely invented. U.S. Pat. No. 4,515,747 invented by Creek et al. (1985) is the only one which can perform lancing work along the periphery of the tube bundle which has a triangular pattern. It is characterized by the use of a transporter which is comprised of three segments which are linked to each other by means of quick disconnect hinges. The two end segments are equipped with wheels vertically mounted on the bottom surface of them which engage the surface of the outermost tube bundle, and with wheels mounted on the side surface of them to stand on the upper surface of the tube sheet. The middle segment is employed as the base plate on which inspection or maintenance devices are to be mounted and transported. An extendable and retractable telescope-type rod is installed into the outer side of the two end segments in order to anchor the transporter in position between the tube bundle and the wall. Both of two end segments of the transporter are tied to two cables which extends outward through the hand holes. They can be driven either manually by persons or mechanically by a automated pulley system located near the hand holes.

As shown in FIG. 2 of the patent, the transporter system is basically devised based on the assumption that the outer bundle of tubes are arrayed regularly on a certain circular line with a constant radius of curvature. In reality, however, this assumption is no longer valid. The outermost tubes are packed irregularly on the tube sheet. As a result, the direction of nozzle jets from the nozzle block mounted on the transporter varies right and left, as the transporter moves along the irregular tube surfaces. This causes misalignment of the nozzle jets with the desired tube lanes. Another probable problem is that there is high possibility of damaging surfaces of the outermost tubes by the transporter when the balance of power between the front and the rear cables is lost during transportation or lancing. In some real situations on the field, some serious accidents related to this problem have been reported. There still exists another possibility that the upper surface of the tube sheet may not be smooth enough due to the existence of undesirable foreign objects or other causes. In this situation, a flat and stable platform for the transportation of the transporter cannot be provided and as a result, an unstability may take place in the movement of the transporter. Furthermore, when adopting extendable and retractable pistons to anchor the transporter between the outer tube bundle and the inner wall of the steam generator, it is basically assumed that the inner wall of the steam generator stands vertically to the upper surface of the tube sheet from the bottom.

However, in real situation, the wall in the lower portion is made round for smooth connection with the tube sheet and therefore, it cannot function well as a solid support wall to the transporter. When the transporter leans against the oblique wall by means of the extendable and retractable pistons during lancing operation, it will apt to slide along the wall. To solve the above-mentioned problems, it is highly desirable to transport the lance system without contacting the upper surface of the tube sheet and the outer surface of the tube bundle and to make it lean against the vertical portion of the inner wall of the steam generator.

To realize this idea, the present invention pursues a lance system along the annulus of a steam generator which is transported along a rigid guide support rail. The guide support rail is composed of two parallel circular rods which are vertically separated with a distance and are tightly fixed inside the hand hole, and have the same radius of curvature. Because the lance system is moved along the periphery of the tube bundle without contacting the surface of the outermost tubes, the possibility of damaging the tube surface during lancing procedure is highly removed. In addition, transportation of the lance system along the guide support rail with the same radius of curvature guarantees highly efficient alignment of the nozzle jets toward the desired tube lanes. Furthermore, the lance system is driven automatically by a drive system positioned outside the steam generator, which also brings forth highly efficient lancing procedure and lowers the possibility of accidents by human mistakes.

### SUMMARY OF THE INVENTION

Accordingly, it is an object of this invention to provide an automated lance system for accessing the annulus of a nuclear power plant steam generator which is universally applicable to different steam generator and other difficult to access geometries.

It is another object of the invention to provide such a lance system which transports along a rigid guide support rail with a constant radius of curvature, extending circumferentially from a hand hole to another hand hole along the annulus of a steam generator, without contacting the surfaces of the outermost tubes and the upper surface of the tube sheet, hence removing the possibility of damaging the tube surfaces and avoiding misalignment of high pressure water jets with the desired tube lanes.

It is a further object of the invention to provide such a system in which the base plane of transportation of the lance has a constant radius of curvature, hence resulting in an easier alignment of the direction of nozzle jets with the predetermined tube lanes in the lancing operation.

It is still another object of the invention to provide such a system in which the lance moves automatically along the extended guide support rail.

It is further another object of the invention to provide such a system in which the angle of the sweeping motion of a nozzle cylinder and the angle of the rotation of a nozzle block containing the nozzle cylinder are enlarged to cover more extended lancing area.

It is still another object of the invention to provide such a system in which a more overall structural stability is achieved in the lancing operation, hence reducing the possibility of structural failure.

The attainment of these and related objects may be achieved utilizing the present novel automated lance system herein disclosed. An automated lance system for accessing the annulus of a steam generator in accordance with this invention comprises a guide support rail, which is composed of two parallel circular rods separated vertically with a distance, is tightly fixed inside the hand hole. The guide rail extends from a hand hole at 0 degree to the other hand hole at 90 or 180 degree. The lance is slidably held on the guide rail by means of supporting circular holders which are attached both on the bottom and on the upper plates of the lance. The lance is comprised of a nozzle block with a nozzle cylinder and a first drive means which makes sweeping motion of the nozzle cylinder, a second drive means which aligns the direction of nozzle jets from the nozzle cylinder by rotating the nozzle block in the horizontal plane, and two side support wheels attached to the outer side plate of the lance, rolling along the inner wall of the steam generator during lancing. To make the lance transport along the guide rail, an articulated body is connected to the rear part of the lance and is driven by a teethed belt system stationed outside the steam generator. The articulated body is composed of a great deal of segments which are linked together by pins and which are held tightly by two parallel control cables, and have lengthwise holes for the passage of high pressure water tubes and an optical cable. The teethed belt system is consisted of a pulley system, a teethed belt, and a drive means which induces linear motion of the teethed belt. Teeth on the teethed belt engage the segments of the articulated body.

### BRIEF DESCRIPTION OF THE DRAWINGS

FIG. 1 is a perspective view of an automated lance system which moves along the annulus of a steam generator in accordance with the invention.

FIG. 2 is a top view of an automated lance system which moves along the annulus of a steam generator in accordance with the invention.

FIG. 3(a) and 3(b) depict a circular rigid guide support rail which is a portion of the automated lance system shown in FIG. 1.

FIG. 4 shows a lance body which is a portion of the automated lance system shown in FIG. 1.

FIG. 5(a) and 5(b) show a front and a rear view of a nozzle block which is a portion of the lance body shown in FIG. 3.

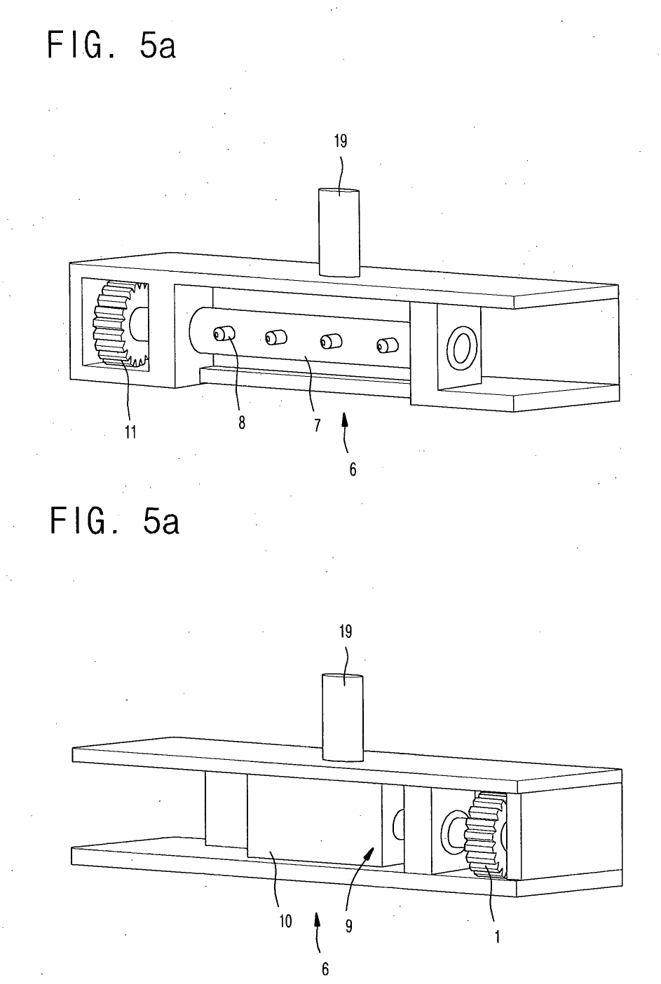

FIG. 6 shows a side support wheel which is a portion of the lance body shown in FIG. 3.

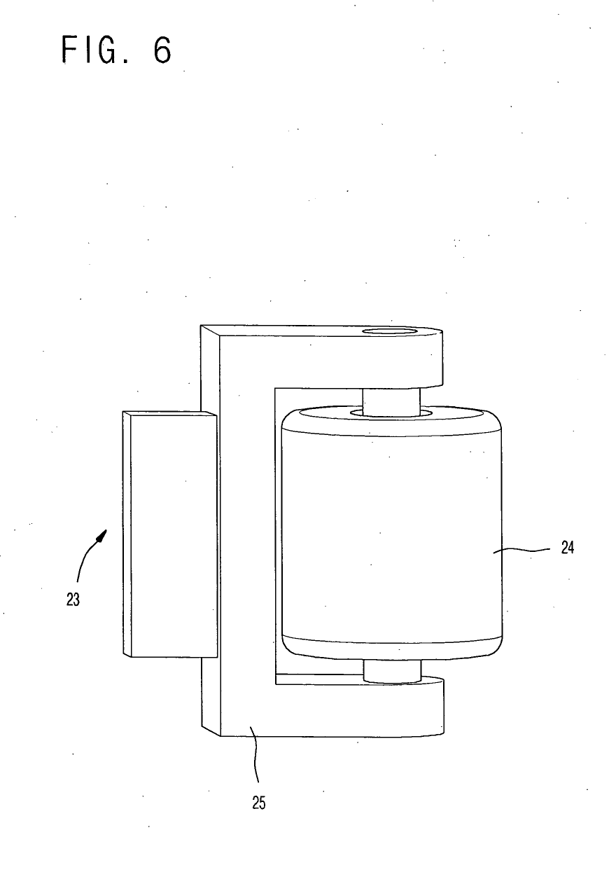

FIG. 7 represents a drive means with a drum to wrap the control cables attached to the lance body.

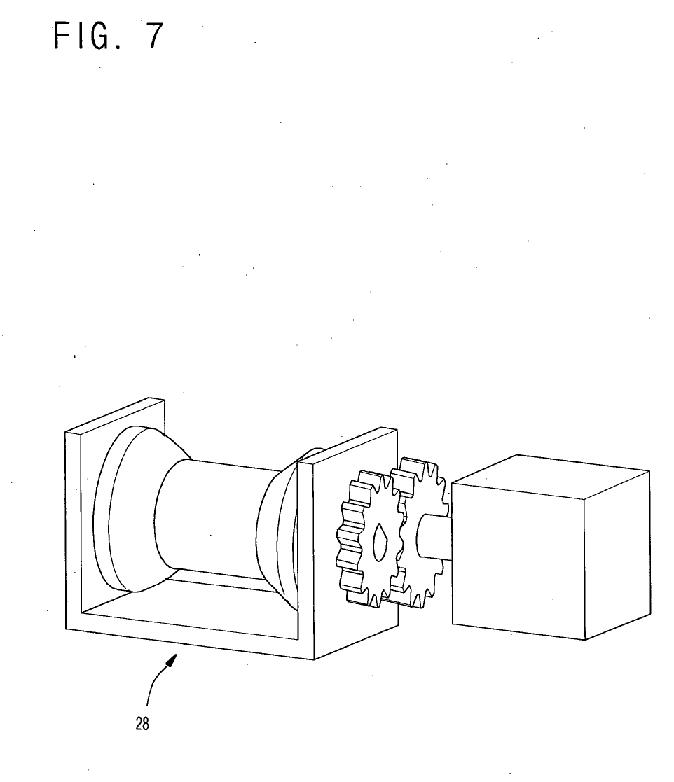

### DETAILED DESCRIPTION OF THE INVENTION

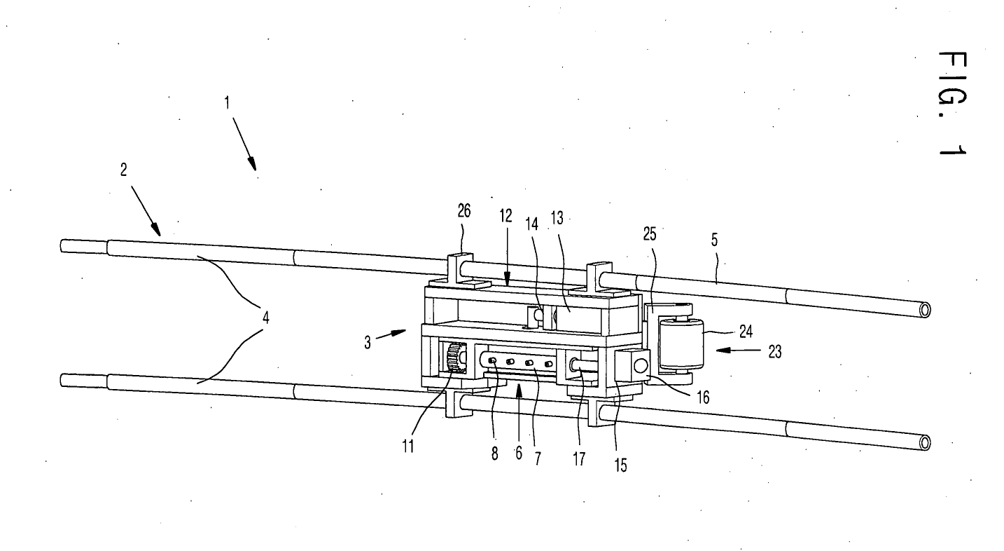

FIG. 1 shows an automated lancing system 1 which performs lancing along the annulus of a steam generator having a tube array of triangular pattern. The lance system is mainly composed of two parts: a rigid guide support rail 2 and a lance body 3 which carries out lancing along the rigid guide support rail.

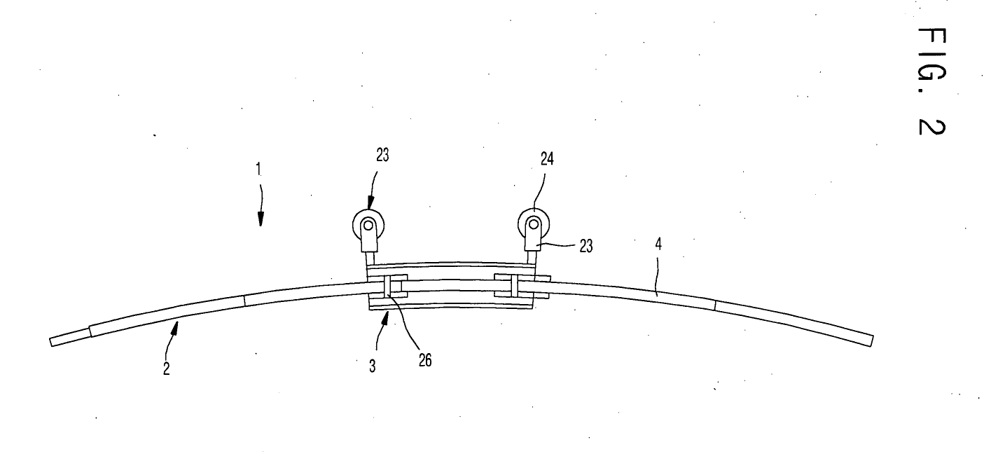

As displayed in FIG. 2, the rigid guide support rail is made of two parallel circular rods 4 with the same radius of curvature whose ends are securely fastened inside the hand hole. It extends circumferentially in the periphery of the tube bundle from a hand hole to another hand hole separated away at 90 or 180 degree from the first one. It functions as a supporter to hold the lance body in the open space of annulus and provides a pathway to the lance body along the annulus. Because the circular guide support rail cannot be inserted in one body due to the spatial constraints imposed by small diameter of the hand holes, it should be composed of several parts 5 and be fabricated inside the hand hole.

In order to carry the fabricated end of the guide support rail to the other hand hole along the periphery of the tube bundle, a small cart 6 which can holds it up needs to be used. By pulling a cable tied to the cart from outside the second hand hole, the end of the guide support rail can be reached to the other hand hole.

As for the material and dimensions of the guide support rail, it must have high stiffness so that it may sustain the lance body in position under the strong repulsive forces generated by the nozzle jets of high pressure water. A control cable is inserted through the parts of the circular rod to securely link them together into a circular guide support rail. Its tension can be controlled mechanically.

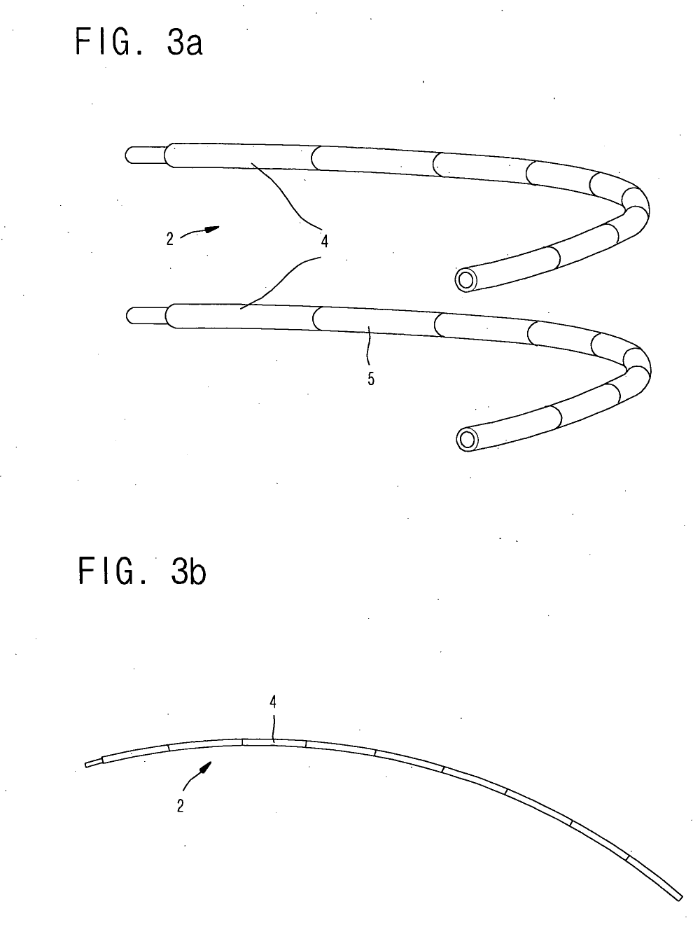

As shown in FIG. 3, the lance body 3 is designed to have a curved shape to move well along the guide support rail. It is consisted of a nozzle block 6 which contains a circular nozzle cylinder 7 with four nozzles 8 installed in, and a drive means 8 with a motor 10 and a gear pair 11 which drives the sweeping motion of the circular nozzle cylinder, and another drive means 12 with a motor 13 and a gear pair 14 which aligns the direction of the nozzle jets in line with the desired tube lanes by rotating the nozzle block, and a guide supporting structure 15 which supports the first and the second drive means which is positioned on the upper plate of it and which sustains and guides the nozzle block when it rotates.

The nozzle cylinder is machined to have a large hole along the centerline as a passage of high pressure water. The length of the nozzle cylinder is to be determined to make the nozzle cylinder freely rotate and to cover wider lancing range. Four small holes are drilled from the surface of the nozzle cylinder to its inner wall. Nozzles are assembled into them. High pressure water can be provided to the circular cylinder through a side surface of it or through the vertical rotational axis of the nozzle block. In the former case, a high pressure reservoir 16 is attached on the side surface of the guide supporting structure. A flexible high pressure water tube 17 is necessary to connect the water reservoir with the circular nozzle cylinder. In this manner, supply of high pressure water can be done without any difficulty.

To avoid interference with the nozzle jets, the bottom plate 18 of the guide supporting structure is cut off. As displayed in FIG. 3, the first drive means which induces the sweeping motion of the circular nozzle cylinder is stationed beside the nozzle block to overcome the spatial constraint imposed by the total limited height of the lance body. A pair of pinion gears 11 are used to transfer the rotational force of the motor axis to the axis of the nozzle cylinder, which creates the sweeping motion of the circular nozzle cylinder. The sweeping angle is not restrained, but in the real operation of the lance, it is enough to make it range between 10 and 90 degree to fully cover the tube sheet. As shown in FIG. 3, for the rotation of the nozzle block in the horizontal plane, a vertical rotational axis 19 is attached on the center of the upper plate 20 of the nozzle block. It penetrates the upper plate of the guide supporting structure. The rotational axis of the second drive means meets perpendicularly the rotation axis 22 of the nozzle block. Accordingly, a pair of bevel gears are selected as a mechanism of power transmission. The two drive means are tightly packed to be water-proof during the high pressure water ejections.

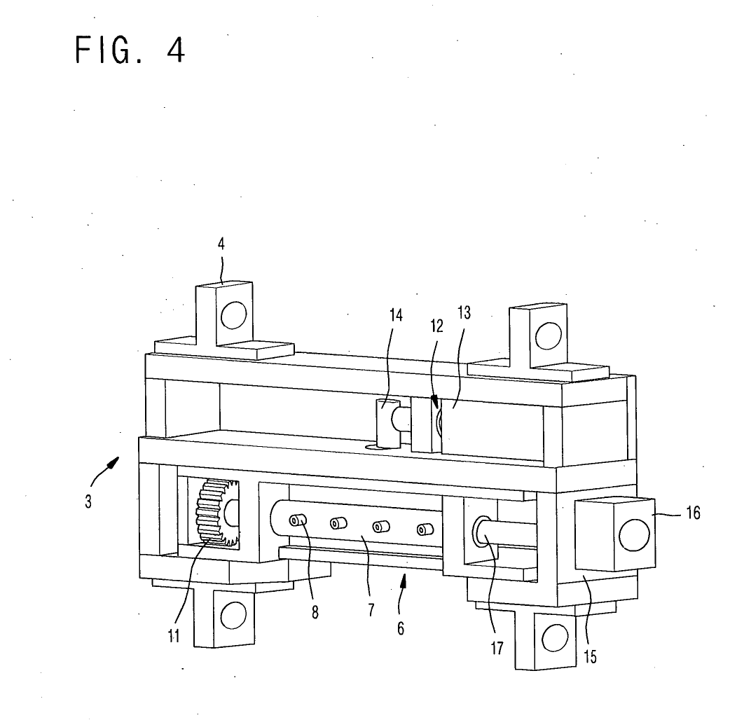

FIG. 4 shows a side support wheel 23. Two side support wheels are attached to the outer side of the lance body to support the lance body and to keep the guide support rail from being bent under the strong repulsive forces taking place by the ejection of high pressure water. As depicted, the side support rail is composed of a wheel assembly 24 which contacts the inner wall of the shell and a flat plate 25 which links the wheel assembly to the side plate of the lance body. Considering the possibility that the surface of the inner wall of the shell may not be smooth at some certain locations, the side support rail has some flexibility in the length. For this purpose, a spring is inserted between the side wall of the lance body and the end of the side supporting rail. The lance body is assembled into the guide support rails by means of holders 26 which are fixed on both the bottom and upper plates of the lance body. The holders slideably move along the guide support rails by supporting the lance body. As shown clearly, since the two parallel circular rods of the guide support rail and the side support rails make a triangular pattern in a radial plane, the lance body can be safely sustained in the lancing operation.

For the transportation of the lance body along the rigid guide support rail, two control cables 27 which extend outward through the hand holes are attached to both ends of the lance body and are driven by a drive means with a drum 28 which is stationed outside the steam generator.

1. An automated lance system which can perform lancing along the annulus of a steam generator with a tube array of a triangular pattern and which comprises, in combination, a lance body which comprises a nozzle block, which comprises a circular nozzle cylinder and a first drive means to make the sweeping motion of said circular nozzle cylinder, and a second drive means to adjust the direction of nozzle jets from said circular nozzle cylinder by rotating said nozzle block in the horizontal plane, a rigid guide support rail which comprises two parallel circular rods which extend circumferentially along said annulus of said steam generator and whose ends are tightly fastened inside the hand hole of said steam generator, and two side support wheels attached to the outer side of said lance body, and two control cables attached to both the front and the real plates of said lance body, said articulated body being driven by a drive means, resulting in the transportation of said lance body along said rigid guide support rail.

2. The system of claim 1 in which said rigid guide support rail comprises several segments, being fabricated inside said hand hole and having a control cable penetrating into said segments to tightly link together said segments, having sufficient stiffness to sustain the repulsive forces caused by said nozzle jets of the high pressure water.

3. The system of claim 1 in which said side support wheels are attached to said lance body with some flexibility in the length by a spring, taking into account of roughness of the inner wall of said steam generator.

4. The system of claim 1 in which two control cables attached to both ends of said lance body are driven by a drive means with a drum which is stationed outside said hand hole.

5. The system of claim 1 in which said lance body is designed to have a curved shape in order to move well along said rigid guide support rail
